(19) United States
(12) Patent Application Publication
(10) Pub. No.: US 2003/0126446 A1
(43) Pub. Date: Jul. 3, 2003

(54) Method and system for providing a secure time reference in a worm environment

(76) Inventors: Jacques Debiez, Cugnaux (FR); James P. Hughes, Lino Lakes, MN (US); Axelle Apvrille, Toulouse (FR)

Correspondence Address: Wayne P. Bailey, Storage Technology Corporation, One StorageTek Drive, MS-4309, Louisville, CO, 80028-4309, US

(21) Appl. No.: 10/034,709

(22) Filed: Dec. 27, 2001

(51) Int. Cl. H04L 9/00

(52) U.S. Cl. 713/178

(57) ABSTRACT

A method and system for providing a secure time reference when storing data to a storage medium using write once read many (WORM) protection are provided. The method includes receiving a message, determining a message digest, appending a published time from a digital time stamping service to the message digest to create a timestamp, and digitally signing the timestamp with a private key of the digital time stamping service. The message, the timestamp, and the digital signature are stored to the medium using write once read many (WORM) protection.

### BACKGROUND OF THE INVENTION

1. Field of the Invention

The present invention relates to a method and system for storing data using write once read many (WORM) protection including using a hardware storage device to write data to a medium wherein data may be written once to the medium, read many times from the medium, but not erased, modified, or overwritten.

2. Background Art

Write once read many (WORM) is a data storage technology that allows information to be written to a medium a single time and prevents the data storage device from erasing, modifying, or overwriting the data. That is, WORM describes media on which data can be written only once, data can never be overwritten, and data is intended to be read back many times. Traditionally, WORM is supported by the media itself, giving an advantage to some optical media that are physically write once, and preventing magnetic media from being used to implement WORM functionality.

WORM protection refers to the protection that prevents the user from erasing, modifying, or overwriting data on the WORM media. Optical media that is physically write once has inherent WORM protection. WORM protection also exists on VOLSAFE cartridges that are commercially available from Storage Technology Corporation, Louisville, Colo. The VOLSAFE tape cartridges have a physical/mechanical lock that prevents data overwriting when associated with a compatible drive. More specifically, the presence of the physical lock on the VOLSAFE tape is detected by specific VOLSAFE supporting drives. When the physical lock is detected, the drives prevent data overwriting. As such, VOLSAFE cartridges and compatible drives make it possible to implement WORM functionality with magnetic media.

Although WORM protection implementations that use optical media and WORM protection implementations that use magnetic media have been used in applications that have been commercially successful, and although existing WORM protection implementations provide some data security, security still lacks some secure time reference. That is, these existing WORM protection systems do not provide a secure time reference for the recorded data. The lack of a secure time reference from the WORM protection system makes it possible to falsify dates of documents, allowing the falsified document to be written to the media using WORM protection without any secure time reference from the WORM protection system. That is, an existing time reference such as a file creation date is not secure and only provides a vague idea of when a file was created, modified, or written, and can be easily manipulated. The WORM protection prevents, within its capabilities, overwriting or modification and maintains data integrity. Nevertheless, there is no specific secure time reference from the WORM protection system for the data, and nothing in the WORM system provides a clear distinction between a document having an authentic data and a document having a falsified date.

For the foregoing reasons, there is a need for a method and system for providing a time reference in a WORM environment.

### SUMMARY OF THE INVENTION

It is therefore an object of the present invention to provide a method and system for providing a secure time reference in a WORM environment that utilizes a digital time stamping service with a private key used to digitally sign a timestamp.

In carrying out the above object, a method of providing a secure time reference when storing data to a medium using write once read many (WORM) protection is provided. The data may be written once to the medium, read many times from the medium, but not erased, modified, or overwritten. The method comprises receiving a message for storing to the medium, determining a message digest based on the message, and establishing a digital time stamping service. The digital time stamping service has a private key and a public key. The digital time stamping service is capable of generating a published time. The method further comprises appending the published time from the digital time stamping service to the message digest to create a timestamp, and digitally signing the timestamp with the digital time stamping service private key. The message, the timestamp, and the digital signature are stored to the medium using write once read many (WORM) protection.

In a preferred embodiment, digitally signing further comprises determining a timestamp digest, and encrypting the timestamp digest with the digital time stamping service private key. The timestamp digest is based on the timestamp. Digests such as the message digest and the timestamp digest are determined using a suitable hash function. In one embodiment, the method further comprises storing the digital time stamping service public key to the medium using write once read many (WORM) protection. In another embodiment, the time stamping service has a public key certificate and the method further comprises storing the digital time stamping service public key certificate to the medium using write once read many (WORM) protection. In some implementations, the medium is a magnetic storage medium.

Further, in carrying out the present invention, a system for providing a secure time reference when storing data to a storage medium using write once read many (WORM) protection is provided. The data may be written once to the storage medium, read many times from the storage medium, but not erased, modified, or overwritten. The system comprises a program medium having instructions stored thereon. The instructions are executable by a processor to perform a method of the present invention. That is, the instructions are executable by a processor to receive a message for storing to the storage medium, and determine a message digest based on the message. A digital time stamping service is established and has a private key and a public key. The digital time stamping service is capable of generating a published time. The published time from the digital time stamping service is appended to the message digest to create a timestamp, and the timestamp is digitally signed with the digital time stamping service private key. Further, the message, the timestamp, and the digital signature are stored to the storage medium using write once read many (WORM) protection.

In a preferred embodiment, digitally signing further comprises determining a timestamp digest, and encrypting the timestamp digest with the digital time stamping service private key. The timestamp digest is based on the timestamp. Digests such as the message digest and the timestamp digest are determined with a suitable hash Function. In one embodiment, the instructions are further executable by the processor to store the digital time stamping service public key to the medium using write once read many (WORM) protection. In another embodiment, the digital time stamping service has a public key certificate, and the instructions are further executable by the processor to store the digital time stamping service public key certificate to the medium using write once read many (WORM) protection. In some implementations, the storage medium is a magnetic storage medium.

The advantages associated with embodiments of the present invention are numerous. For example, methods and systems of the present invention add tamper proof time stamping capabilities to a WORM system to provide better security of backups and archives. Such advantages are particularly useful for those who need to store data for a long period of time (many years for instance) and may need to prove authenticity and date of the data. In accordance with the present invention, completely new data forged with correct hashes to counter data integrity detection would be detected due to the inability to forge the timestamp.

The above object and other objects, features, and advantages of the present invention are readily apparent from the following detailed description of the preferred embodiment when taken in connection with the accompanying drawings.

### BRIEF DESCRIPTION OF THE DRAWINGS

FIG. 1 is a block diagram illustrating a method of the present invention for providing a time reference when storing data to a medium using write once read many (WORM) protection;

FIG. 2 is a block diagram illustrating digitally signing the timestamp with the digital time stamping service private key in a preferred embodiment; and

FIG. 3 graphically illustrates a preferred method and system of the present invention.

### DETAILED DESCRIPTION OF THE PREFERRED EMBODIMENTS

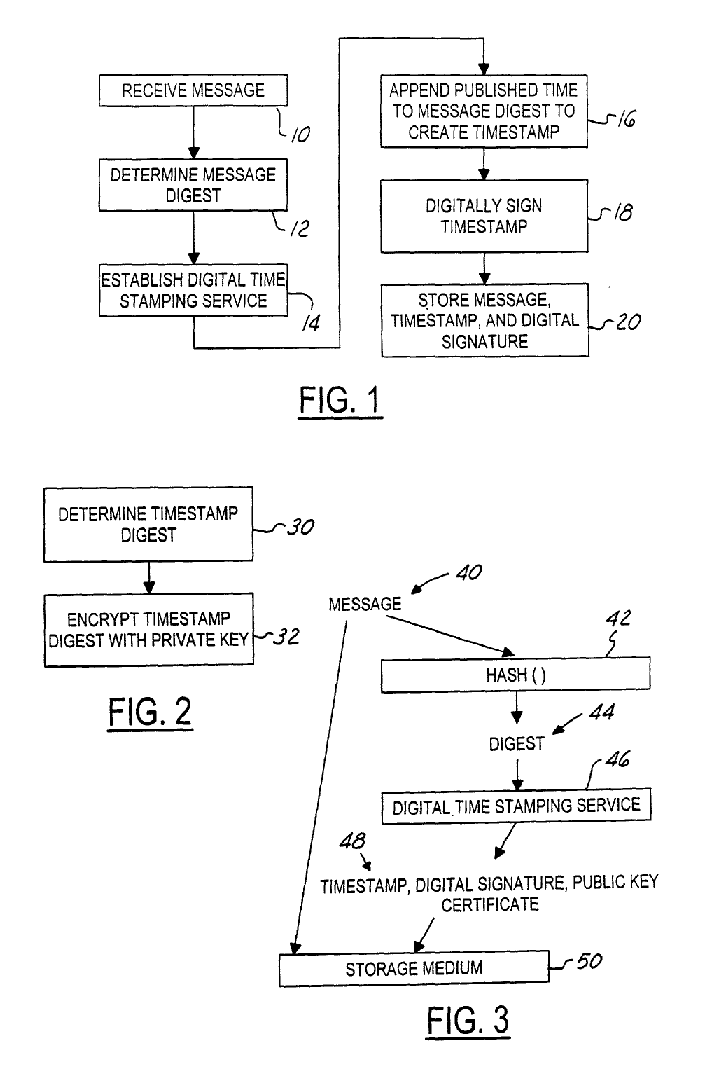

FIG. 1 illustrates a method of providing a secure time reference when storing data to a medium using write once read many (WORM) protection. That is, the data may be written once to the medium, read many times from the medium, but not erased, modified, or overwritten. At block 10, a message is received for storing to the medium. At block 12, a message digest based on the received message is determined.

In a preferred embodiment, the message digest is determined using a hash function. In the security field, data integrity is often achieved with the use of a hash function. A hash function is a transformation that transforms an input to a fixed size string. Hash functions have a number of general uses. A cryptographic hash function is used in the security field to achieve data integrity. A cryptographic hash function is a one-way function that digests input data and has very few collisions. A one-way function is a function that is very difficult to invert. That is, data can be processed through the one-way hash function to get a result, but it is very difficult to reverse the function and obtain the data with the result. A cryptographic hash function digests input data in that the output is much smaller in size than the input data. For example, many pages of text may be digested by a cryptographic hash function to produce a 20 byte hash. In addition, a cryptographic hash function has very few collisions in that two different initial texts have very little chance of producing the same hash.

The capabilities of the cryptographic hash function are commonly used to provide data integrity. An existing data integrity check method using a cryptographic hash function involves the following. First, a data block or sequence of data blocks is received. The data is hashed using a cryptographic hash function or hash algorithm. The data and the hash are both stored (the hash is small compared to the data because the cryptographic hash function digests the data). To conduct the data integrity check, the data and the hash are retrieved from the storage medium. The data is then hashed using the hash function, and the obtained hash is compared with the stored hash that was retrieved from the storage medium. If both the originally stored hash and the recalculated hash are the same, then the data is considered authentic, that is, the data has not been modified. If the data had been replaced with some other data, then the hash of the other data that is calculated when the data is retrieved would not correspond to the original stored hash that was calculated when the data was stored. This existing process is useful in many applications because the process allows detection of modified data by comparing two hashes.

It is appreciated that the above description of a hash function, a cryptographic hash function, and an existing data integrity check method are presented as a suitable technique for determining the message digest at block 12. At block 14, a digital time stamping service is established. It is appreciated that in prior art methods and systems for storing data using WORM protection, there are not any time stamping capabilities. In accordance with the present invention, at block 16, a published time from the digital time stamping service is appended to the message digest (determined at block 12) to create a timestamp. The digital time stamping service is capable of generating a published time on request, and has a private key and a public key. The private key is kept secret. At block 18, the timestamp digitally signed with the digital time stamping service private key to create a digital signature. Because the private key is kept secret, the digital signature cannot be forged. At block 20, the message, the timestamp, and the digital signature are stored to the medium using write once read many (WORM) protection.

Suitable techniques for public/private key encryption are apparent to those of ordinary skill in the art. Public key encryption uses a pair of asymmetric keys for encryption and decryption. The private key is kept secret, and the public key is made available to the public. Data that is encrypted with the public key can be decrypted only with the private key. Data encrypted with the private key can be decrypted only with the public key. As such, because the timestamp is digitally signed with the digital time stamping service private key, the encrypted information can be decrypted only with the public key. In addition, when decryption with the public key produces meaningful information, the information must have been encrypted with the private key.

FIG. 2 illustrates a preferred method for digitally signing the timestamp. At block 30, a timestamp digest is determined based on the timestamp. At block 32, the timestamp digest is encrypted with the digital time stamping service private key. That is, in a preferred embodiment, digital signing a collection of data means taking the digest of the data and encrypting the digest with a private key. The encrypted digest is the digital signature of the data. Accordingly, when data is stored together with the digital signature of the data, the digital signature allows both authenticity and integrity to be checked. Using the public key to decrypt the encrypted message digest authenticates that the message digest was encrypted with the private key of the key pair and thus was signed by the owner of the private key. Digesting the message and comparing the digest with the decrypted message digest allows data integrity to be checked. That is, if the newly determined message digest matches the decrypted message digest, the data has been received intact and has not been modified. It is appreciated that various techniques may be utilized for the private/public key encryption and digital signing without departing from the present invention.

A preferred embodiment of a system and method of the present invention is graphically illustrated in FIG. 3. A message is generally indicated at 40. The message is processed by hash finction 42 to produce digest 44. Digest 44 is sent to digital time stamping service 46 to obtain a timestamp. Digital time stamping service 46 returns a timestamp and digital signature. In addition, digital time stamping service 46 may return a public key certificate or a public key. Alternatively, the public key may be widely distributed so that it does not have to be returned by digital time stamping service 46.

The digital time stamping service may rely on an external trusted organism, or may rely on a trusted internal time source. When reading the data from storage medium 50, the timestamp and digital signature may be used to determine data integrity and timestamp authenticity. It is appreciated that methods and systems of the present invention add tamper proof time stamping capabilities to a WORM system to provide improved security of backups and archives.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of providing a secure time reference when storing data to a medium using write once read many (WORM) protection, wherein the data may be written once to the medium, read many times from the medium, but not erased, modified, or overwritten, the method comprising:
receiving a message for storing to the medium;
determining a message digest based on the message;
establishing a digital time stamping service having a private key and a public key, and capable of generating a published time;
appending the published time from the digital time stamping service to the message digest to create a timestamp;
digitally signing the timestamp with the digital time stamping service private key to create a digital signature; and
storing the message, the timestamp, and the digital signature to the medium using write once read many (WORM) protection.

2. The method of claim 1 wherein digitally signing further comprises:
determining a timestamp digest based on the timestamp; and
encrypting the timestamp digest with the digital time stamping service private key.

3. The method of claim 1 further comprising:
storing the digital time stamping service public key to the medium using write once read many (WORM) protection.

4. The method of claim 3 wherein the digital time stamping service has a public key certificate, the method further comprising:
storing the digital time stamping service public key certificate to the medium using write once read many (WORM) protection.

5. The method of claim 1 wherein the medium is a magnetic storage medium.

6. A system for providing a time secure reference when storing data to a storage medium using write once read many (WORM) protection, wherein the data may be written once to the storage medium, read many times from the storage medium, but not erased, modified, or overwritten, the system comprising a program medium having instructions stored thereon, the instructions being executable by a processor to:
receive a message for storing to the storage medium;
determine a message digest based on the message;
establish a digital time stamping service having a private key and a public key, and capable of generating a published time;
append the published time from the digital time stamping service to the message digest to create a timestamp;
digitally sign the timestamp with the digital time stamping service private key to create a digital signature; and
store the message, the timestamp, and the digital signature to the storage medium using write once read many (WORM) protection.

7. The program medium of claim 6 wherein digitally signing further comprises:
determining a timestamp digest based on the timestamp; and
encrypting the timestamp digest with the digital time stamping service private key.

8. The program medium of claim 6 wherein the instructions are further executable by the processor to:
store the digital time stamping service public key to the medium using write once read many (WORM) protection.

9. The program medium of claim 8 wherein the digital time stamping service has a public key certificate, and wherein the instructions are further executable by the processor to:
store the digital time stamping service public key certificate to the medium using write once read many (WORM) protection.

10. The program medium of claim 6 wherein the storage medium is a magnetic storage medium.
